(19) United States
(12) Patent Application Publication
(10) Pub. No.: US 2011/0296778 A1
(43) Pub. Date: Dec. 8, 2011

(54) PRE-MANUFACTURED UTILITY WALL

(76) Inventors: Arlan E. Collins, Seattle, WA (US); Mark L. Woerman, Seattle, WA (US)

(21) Appl. No.: 13/155,319

(22) Filed: Jun. 7, 2011

Related U.S. Application Data
(63) Continuation-in-part of application No. 12/796,625, filed on Jun. 8, 2010.
Application No. 12/796,625 is a continuation-in-part of application No. 12/796,603, filed on Jun. 8, 2010.

(51) Int. Cl. E04C 2/52; E04B 2/58; B23P 11/00; E04B 5/48

(52) U.S. Cl. 52/220.1; 52/173.1; 52/745.1; 29/428

(57) ABSTRACT

The present invention relates to pre-manufactured utility walls that may be readily adapted for use in multi-story building construction. The present invention efficiently and conveniently consolidates utility components typically found in residential, institutional and/or commercial settings into a pre-manufactured, preassembled and, optionally, pre-bundled component at a site other than the building site.

### RELATED APPLICATIONS

This application is a continuation-in-part of copending U.S. patent application Ser. No. 12/796,625, filed Jun. 8, 2010, titled “Construction System And Method For Constructing Buildings Using Premanufactured Structures.” The entirety of this application is incorporated herein by reference.

This application is a continuation-in-part of copending U.S. patent application Ser. No. 12/796,603, filed Jun. 8, 2010, titled “Premanufactured Structures For Constructing Buildings.” The entirety of this application is incorporated herein by reference.

### FIELD OF THE INVENTION

The present invention relates generally to the construction industry, and relates more specifically to pre-manufactured utility walls. The pre-manufactured utility walls of the present invention may be pre-plumbed, pre-wired, prefinished, preassembled, and pre-bundled double stud walls, and may comprise electrical and communications wiring for adjacent walls, an electrical service panel, water heater, kitchen and bath plumbing, fans, support for interior cabinets, and a toilet mounting support with a water-resistant interior surface, a vapor barrier, insulation, plumbing chase, studs for framing, and a water and air barrier with a water resistant exterior surface.

The pre-manufactured utility walls can be specifically adapted for use in construction of multi-story buildings. The pre-manufactured utility walls may be stacked in a vertical fashion so that utility components may be shared between floors of a multi-story building. The pre-manufactured utility walls may also be specifically adapted for use in lift-slab construction. The pre-manufactured utility walls may be designed for space efficiency, easy transport, and rapid installation.

### BACKGROUND OF THE INVENTION

Conventional residential, institutional and commercial construction typically involves extension of various utility lines into a unit space so that utilities may be installed and connected during the final phases of building construction. Installation of individual utility components and connection to pertinent main supply and waste resources is typically a time-consuming and costly phase of building construction. The skills of various trades people are typically required, and coordination of the various trades are difficult to organize and construction often proceeds in a piecemeal fashion depending on the work performed by the various trades people.

### BRIEF SUMMARY OF THE INVENTION

The inventors have discovered that normal utility components found in a residence, institutional or commercial setting can be efficiently and conveniently consolidated and assembled into a single pre-manufactured component at a site other than the building site. By grouping these normal utility components together in a standardized fashion, the installation of utilities for a given building unit can occur more quickly, in a matter of hours rather than days or weeks and at a reduced cost. In addition to cheaper, faster, and more organized and reliable construction, the pre-manufactured utility walls of the present invention also provide other benefits including, but not limited to, increased consistency and quality of craftsmanship, reduced exposure of the various utility components to undesirable elements due to their fabrication in a controlled environment, more environmentally-sound and socially responsible construction practices, and increased convenience and accessibility to utility components for maintenance.

In a preferred embodiment, the pre-manufactured utility walls of the present invention present are assembled as follows: (a) laying out the bottom and top plates of the wall to a predetermined length based on a standard template; (b) pre-punching the bottom and top plates to correspond with penetrations in the slab per a specified template; (c) manufacturing a non-weight bearing double stud wall with metal studs and fasteners to fit within stud runners located within the pre-punched bottom and top plates of predetermined length; (d) installing reinforcement plates, lifting rods and framing pockets within the non-weight bearing double stud wall to assist moving, hoisting and transportation of the finished wall; (e) installing the water heater or other heating systems and accessories within the cavity area and all supply and waste plumbing to prescribed locations within the non-weight bearing double stud wall; (f) installing all fire protection piping to prescribed locations within the non-weight bearing double stud wall; (g) installing an electric panel, wiring and outlets to prescribed locations within the non-weight bearing double stud wall; (h) attaching blocking at predetermined locations on the interior side of the non-weight bearing double stud wall to act as reinforcing for interior casework and fixtures; (i) installing acoustic blanket insulation within the cavity of interior metal stud wall; (j) installing thermal batt insulation within the cavity of exterior metal stud wall; (k) attaching one layer of exterior sheathing board to the exterior side and one layer of interior sheathing board to the interior side of the non-weight bearing double stud wall; (l) applying a weather resistive barrier to the exterior side of the exterior sheathing board; (m) attaching horizontal furring to the exterior side of the exterior sheathing board; (n) installing rigid insulation between the horizontal furring; (o) attaching vertical furring to the horizontal furring on the exterior side of the exterior sheathing board; (p) installing exterior finished panels and associated flashing components to vertical furring channels; (q) installing the access panel on the exterior side of the non-weight bearing double stud wall; (r) installing interior finish material on the interior sheathing board.

The present invention of a pre-manufactured utility wall may also incorporate the possibility of RF controls, heating and cooling ducting or piping, and gas piping. The present invention may further utilize recycled products and materials and incorporate alternative energy sources and methods of environmental control. The foregoing and other objectives, features, and advantages of the invention will be more readily understood upon consideration of the following detailed description of the invention, taken in conjunction with the accompanying drawings.

The particular materials and methods used to assemble the utility walls of the present invention, and the particular sequence of construction steps disclosed in connection with the utility walls as described in detail herein, are exemplary embodiments of the present invention only and are, in no way, intended to be limiting.

### BRIEF DESCRIPTION OF THE DRAWINGS

The accompanying drawings, which are incorporated in and constitute a part of this specification, illustrate various exemplary embodiments.

FIG. 1 illustrates a fully completed utility wall.

FIG. 2 illustrates in a cut away view of the components that make up the completed utility wall.

FIG. 3 illustrates the bottom and top plates, attachment of stud runners and pre-punched holes that will be used to create the non-weight bearing double stud wall.

FIG. 4 illustrates metal stud placement with fasteners within the bottom and top plates creating the non-weight bearing double stud wall.

FIG. 5 illustrates the addition of reinforcement plates, lifting rods and framing pockets at the base of the wall.

FIG. 6 illustrates the installation of supply and waste piping and vent ducting to pre-designated locations, and installation of the water heater within the wall cavity.

FIG. 7 illustrates the installation of the fire protection system within the double wall cavity.

FIG. 8 illustrates the installation of the electrical panel to the outer face of the exterior stud and associated wiring and outlets.

FIG. 9 illustrates the installation of blocking to the face of the interior stud.

FIG. 10 illustrates the installation of acoustical blanket insulation within the interior metal stud wall.

FIG. 11 illustrates the installation of the thermal batt insulation within the exterior metal stud wall.

FIG. 12 illustrates the attachment of one layer of sheathing board and applied to the exterior and interior faces with fasteners and the application of the weather resistive barrier applied to the exterior face.

FIG. 13 illustrates the installation of horizontal furring on the exterior face of the exterior sheathing board with fasteners.

FIG. 14 illustrates the installation of rigid insulation between the horizontal furring and the attachment of vertical furring channels to the horizontal furring with fasteners.

FIG. 15 illustrates the application of the finished exterior and interior panels.

FIG. 16 illustrates the installation of the access panel/door, associated gaskets and flashings and the vent hood and trim.

### DETAILED DESCRIPTION OF THE INVENTION

Before describing the invention and the figures, some of the terminology should be clarified. Please note that the terms and phrases may have additional definitions and/or examples throughout the specification. Where otherwise not specifically defined, words, phrases, and acronyms are given their ordinary meaning in the art. Exemplary embodiments may be better understood with reference to the drawings, but these embodiments are not intended to be of a limiting nature.

The utility walls of the present invention may be pre-manufactured and pre-bundled wall with preassembled sections. The utility walls may include kitchen and bath plumbing, a unit's electrical service panel, exhaust vents/fans, HVAC/gas, and any associated electrical and communications distribution wiring for the adjacent walls. The utility wall's plumbing may include the kitchen and bath supply, waste lines and vent ducting. The utility wall may have a finished interior surface and contain pre-installed exhaust vents/fans and vent trims. The utility wall further may include thermal and sound insulation, encapsulate a unit's plumbing chase, and an exterior sheathing and a weather resistive barrier. The utility wall may have a finished exterior surface, and may include fire-rated sheathing and insulation to act as integral air and vapor barrier. Furthermore, the utility wall may include features that allow the stacking and connection of utilities from one building level to the next which permits ready construction of multi-story buildings.

As used herein, “pre-manufactured” refers to construction manufacture that occurs wholly or in part at a location other than the building site.

As used herein, “preassembled” refers to the assembly of the various utility wall components that occurs wholly or in part at a location other than the building site.

As used herein, “pre-bundled” refers to utility wall component(s) that are protected, packaged, secured or otherwise made ready for transportation to the building site.

The kitchen unit of the present invention may be pre-manufactured and preassembled kitchen unit and may include cabinets, preinstalled plumbing, plumbing connections, electrical wiring, vent ducting, countertops, at least one sink, exhaust vents/fans and light fixtures to be installed in the kitchen on the utility walls.

The bathroom vanity of the present invention may include at least one sink and have preinstalled plumbing for installation on, or connection to, the bathroom on the utility walls.

The cabinets of the present invention may be pre-manufactured and preassembled cabinets that may include integral exhaust fans, light fixtures, refrigerator and/or washer and dryer for installation on, or connection to, the utility walls.

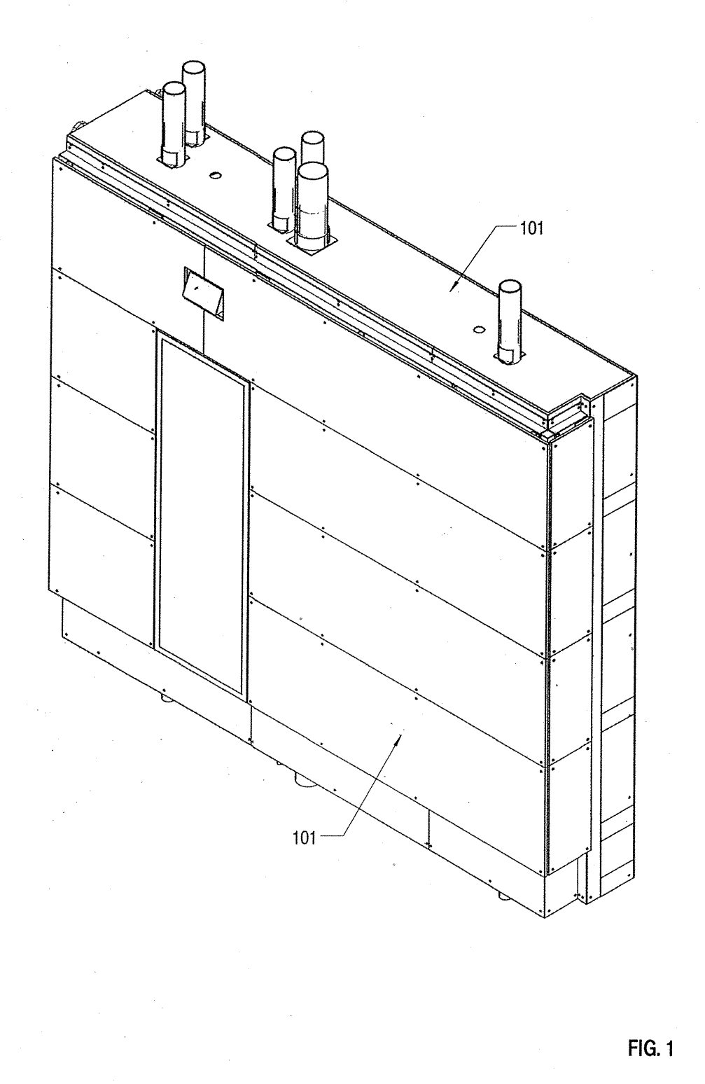

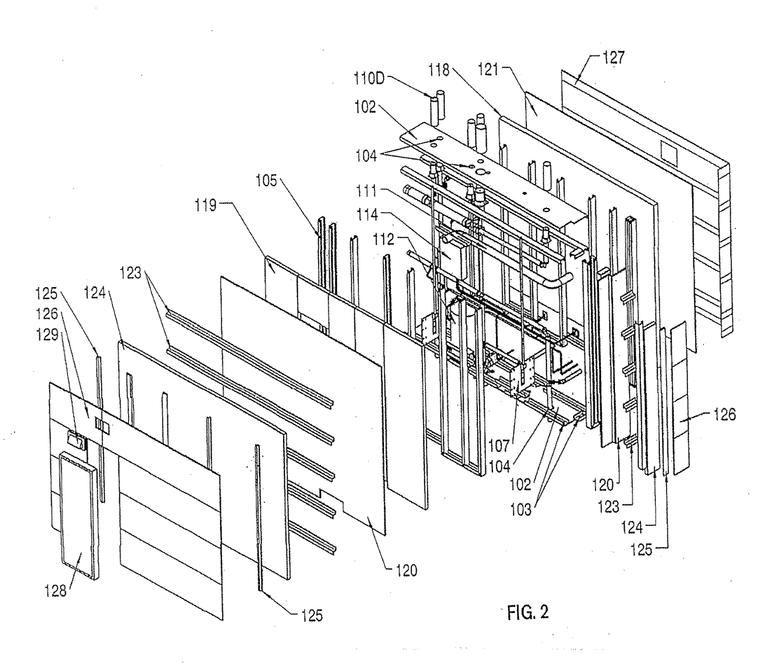

Referring in detail to the drawing figures, FIG. 1 illustrates a fully completed utility wall 101. The utility wall 101 may come in various lengths, but the preferred length is ten feet for ease of transporting and installing the utility wall 101. Each unit has a utility wall 101 at the end of every kitchen and bathroom and is comprised of one or more sections of utility wall 101. The utility wall 101 houses common mechanical, plumbing, electrical, and fire protection risers that serve the units. All of the utilities to and from the units may be conveniently accessed at the utility wall 101. FIG. 2 illustrates a cut-away view showing the components that make up the utility wall 101.

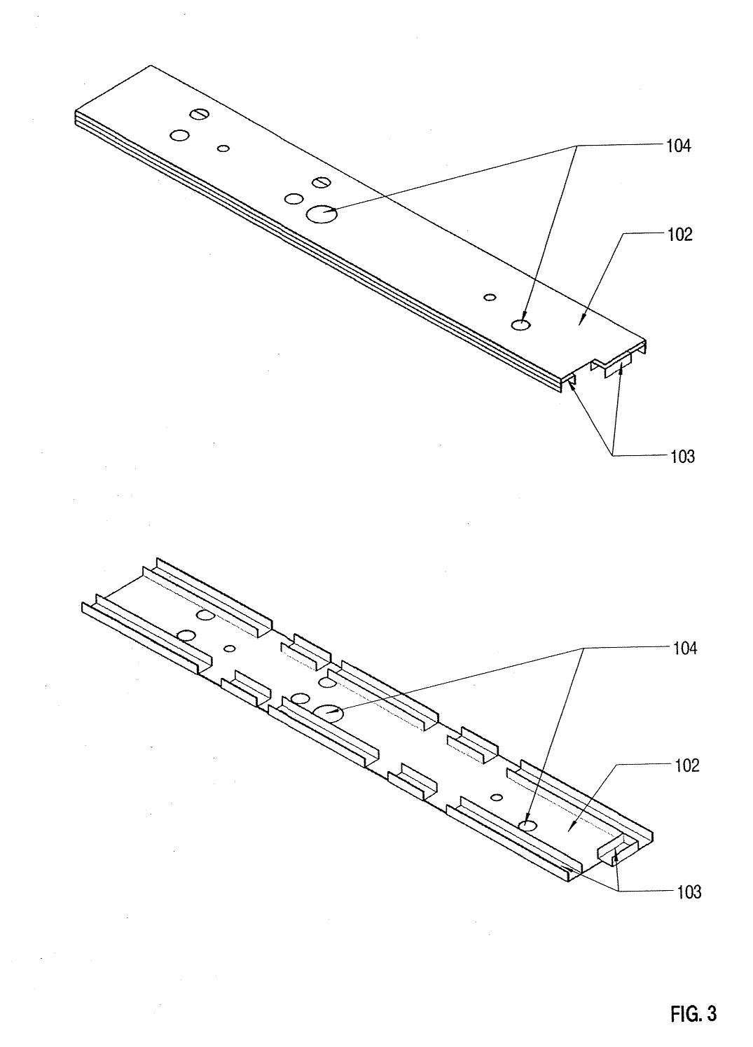

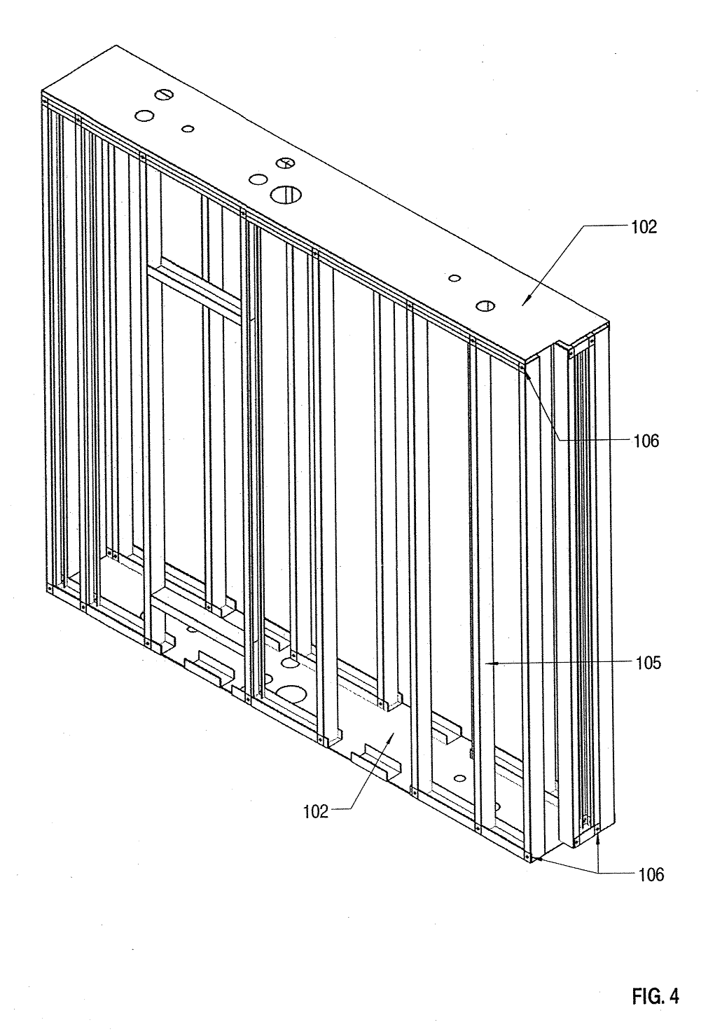

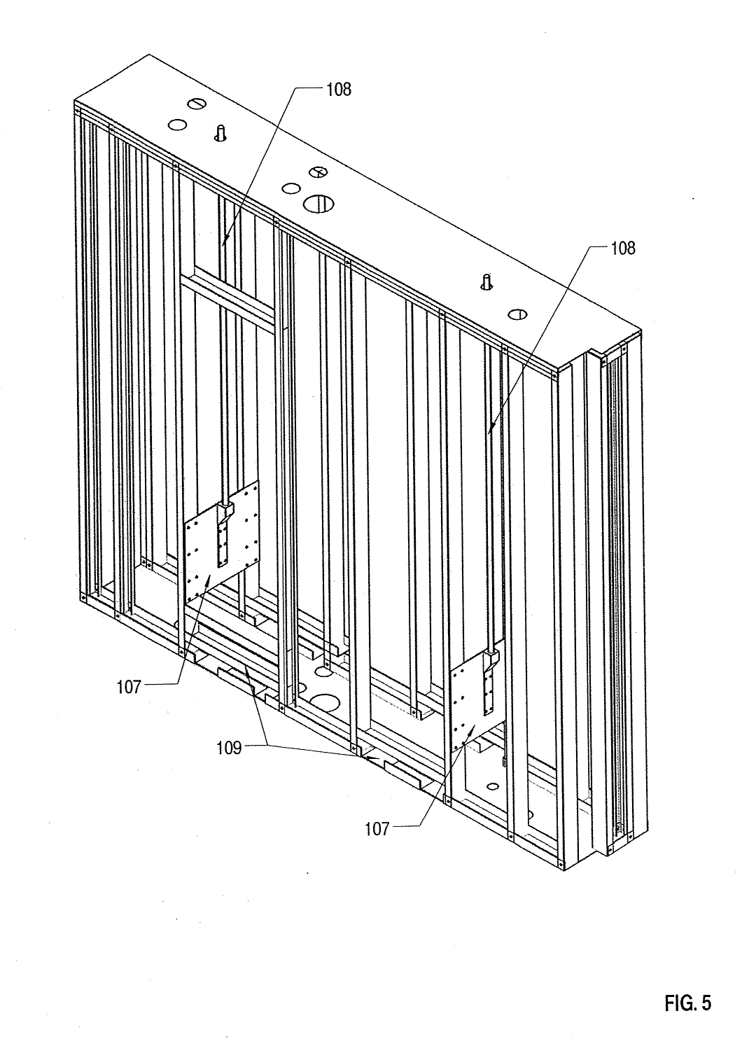

FIG. 3 illustrates bottom and top plates 102 cut to predetermined lengths which will create the frame for the utility wall 101. Metal stud runners 103 are attached to the bottom and top plates 102 with appropriate fasteners. The bottom and top plates 102 are pre-punched 104 per a template that locates the exact position of penetrations for the supply and waste plumbing as well as electrical wiring and fire protection piping to run vertically through a multi-story building. This feature permits vertical stacking of the utility wall for construction of multi-story buildings. FIG. 4 illustrates the placement of the metal stud framing 105 with fasteners 106 within the bottom and top plates 102. The locations of these vertical studs are coordinated precisely with the locations of the interior components that comprise the kitchen unit, cabinets and bathroom vanity. It should be noted that the present invention does not preclude the use of varying stud sizes, gauges or spacing. Reinforcement plates 107, lifting rods 108 and framing pockets 109 are next attached to the double stud wall as shown in FIG. 5 to assist in the moving, hoisting and transportation of the utility wall 101 to the project site.

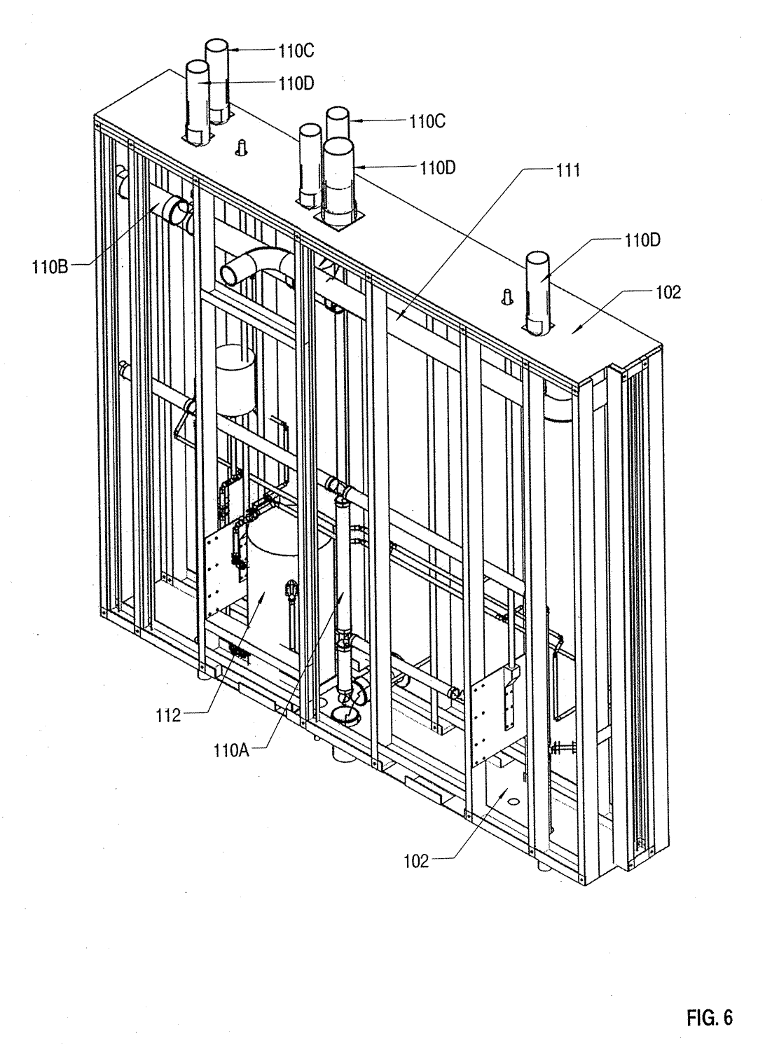

The next step of constructing a utility wall for the present invention involves installing the supply and waste plumbing and extending these lines vertically above the top plate 102 to connect with the utility walls 101 above in a multi-story building scenario. FIG. 6 illustrates the placement of the supply and waste plumbing 110A-B within the cavity of the utility wall 101 as determined by a specified template whereas all of the pieces have been precut to fit. Routing of vent ducting 111 also takes place at this time. The water heater 112 is located within the wall cavity and the piping is connected to it at this time. It should be noted that this invention does not preclude the elimination of the water heater within the utility wall and the introduction of central supply tank or a tankless water heater.

As shown in FIG. 6, the supply and waste lines 110C-D are sleeved beyond the top plate 102 as a means of connecting risers in a vertical orientation within a multi-story building. In an exemplary multi-story building, units are identically stacked vertically on each level of the multi-story building. The utility walls 101 are similarly identical in construction of each unit and are also stacked vertically on each level of the multi-story building. The supply and waste piping sleeves of one exemplary utility wall 101 extend through the top plate 102 enough to extend through the floor system and into the bottom plate 102 of the second exemplary utility wall 101 located on the level above of a multi-story building. In an exemplary multi-story building, units and levels are identically stacked vertically throughout the building with the exemplary utility wall 101 stacked as described above. As the utility wall 101 is placed into position, the piping extensions 110C-D penetrate through the top plate 102 and the floor system and into the bottom plate 102 of the utility wall 101 above. The utility wall 101 is subsequently anchored into position using a variety of methods available. After secure attachment of the utility wall 101 to the floor, connections are made through the lower portions of the exemplary utility wall 101 for supply and waste sleeves 110C-D. This process is repeated for as many levels as required to complete the multi-story building.

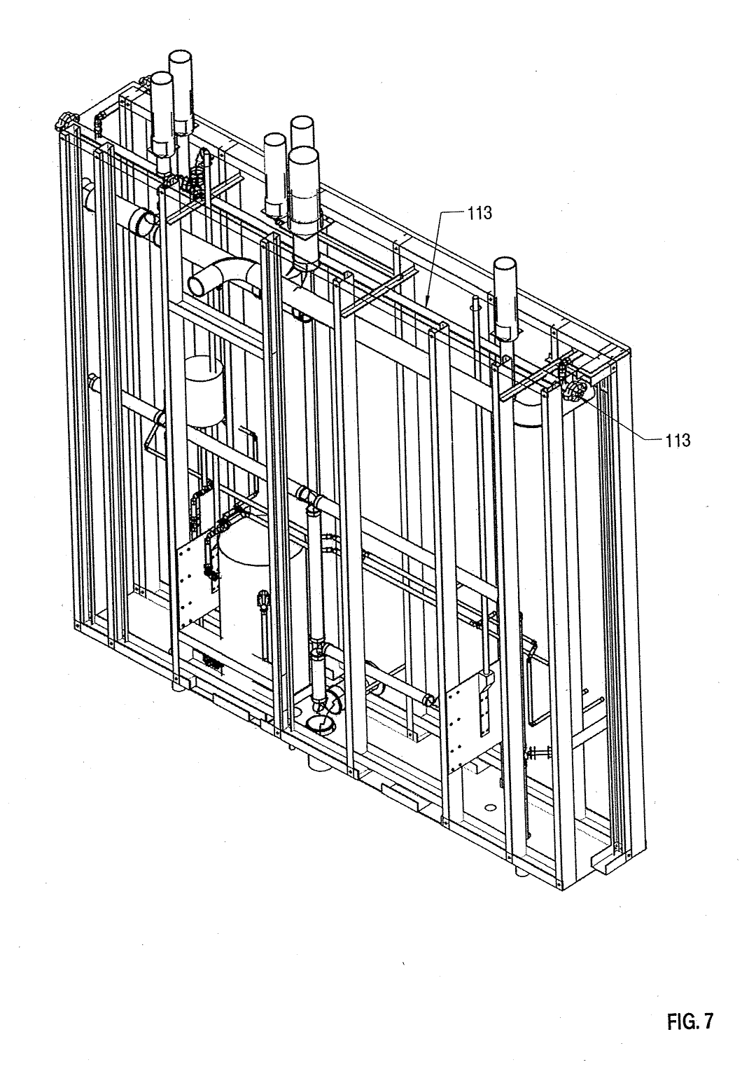

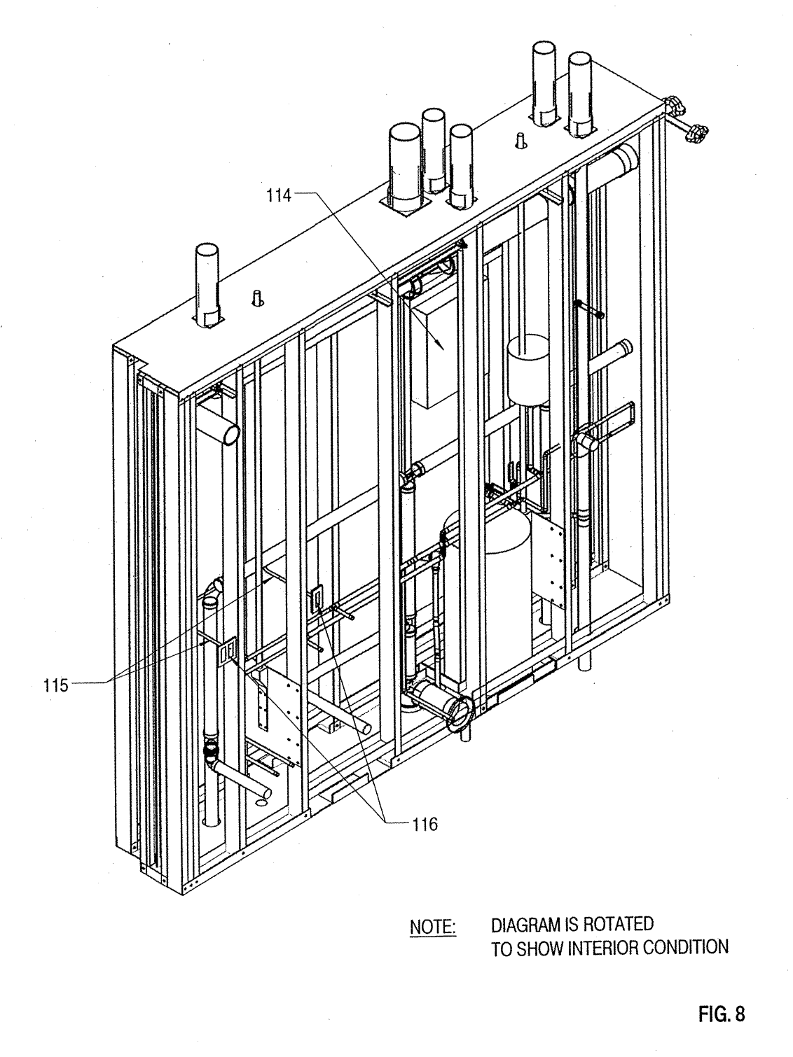

The next step of constructing a utility wall for the present invention involves installing the fire protection piping and electrical wiring as shown in FIGS. 7-8. Illustrated in FIG. 7 is the placement of the fire protection system 113 within the cavity of the utility wall 101. FIG. 8 illustrates the installation of the electrical panel 114 to the outer face of the exterior stud of the utility wall 101, and the running of electrical wiring 115 and outlets 116 within the utility wall 101 to prescribed locations.

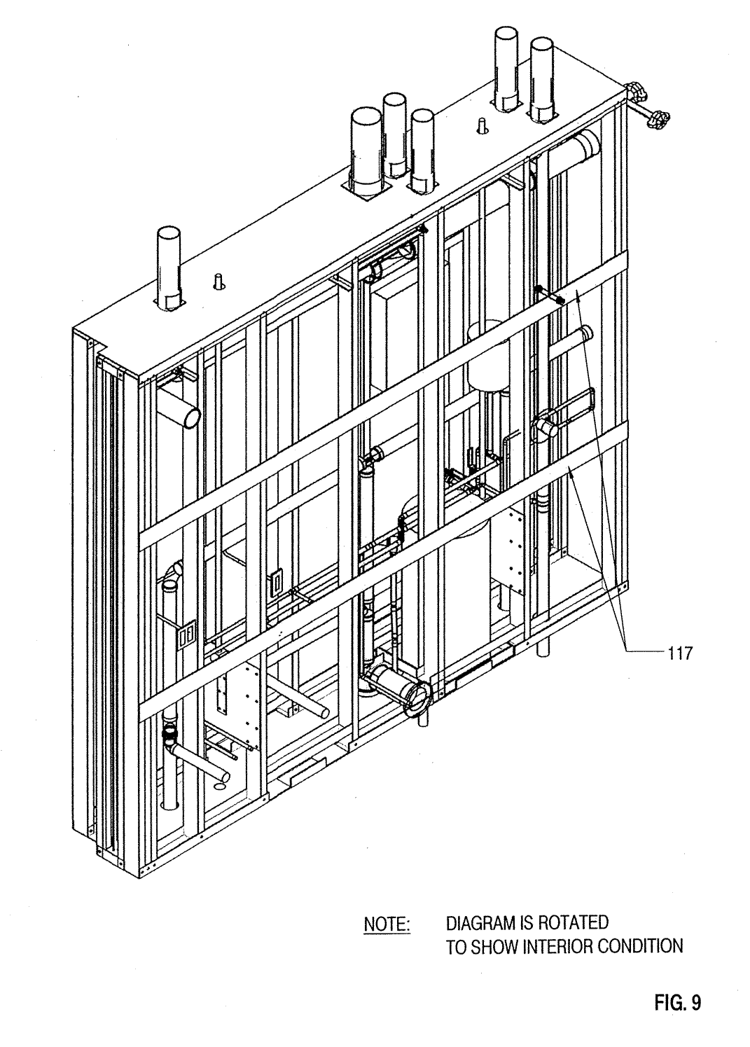

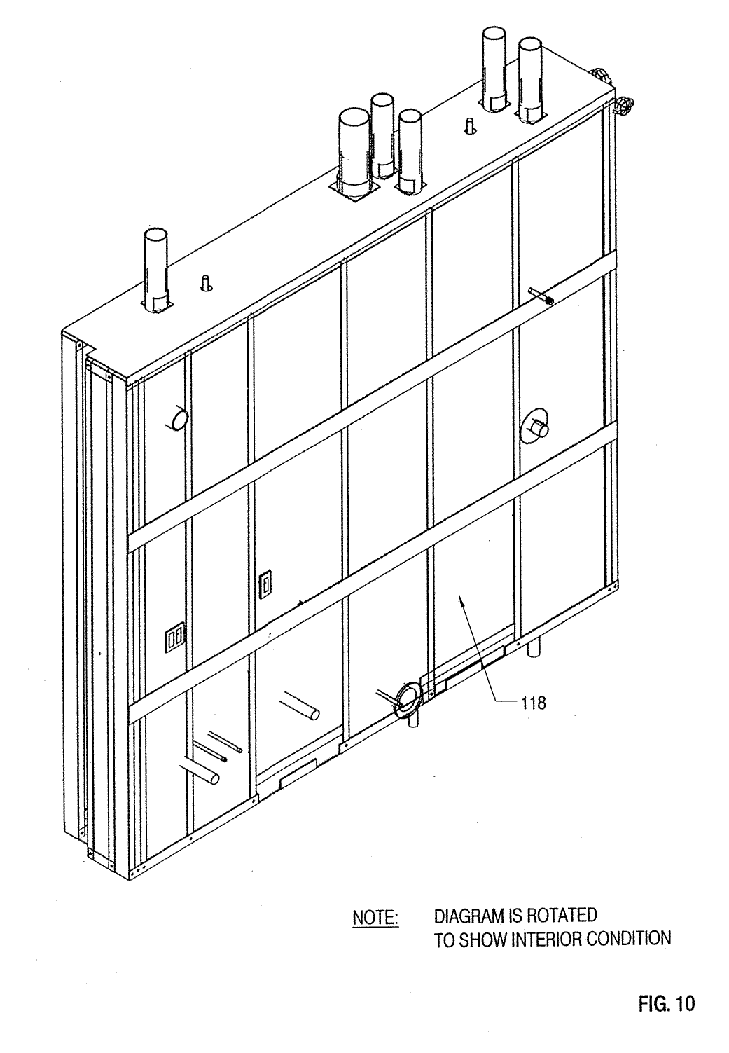

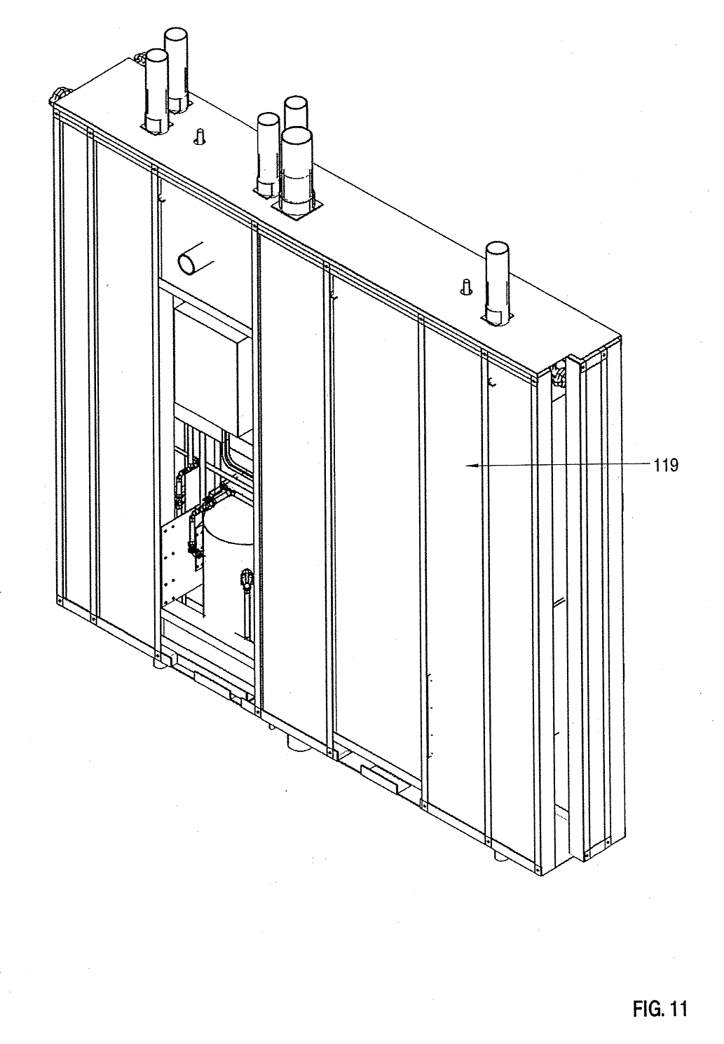

As shown in FIG. 9, blocking 117 is attached on the interior face of the interior stud on utility wall 101. The precut pieces are attached using standard screws at prescribed locations to be utilized as support for the interior fixtures, kitchen counters and kitchen cabinets. It should be noted that wood or metal blocking can be used in the present invention. FIG. 10 illustrates the installation of the acoustic blanket insulation 118 within the stud framing of the interior wall while FIG. 11 illustrates the installation of the thermal batt insulation 119 within the stud framing of the exterior wall.

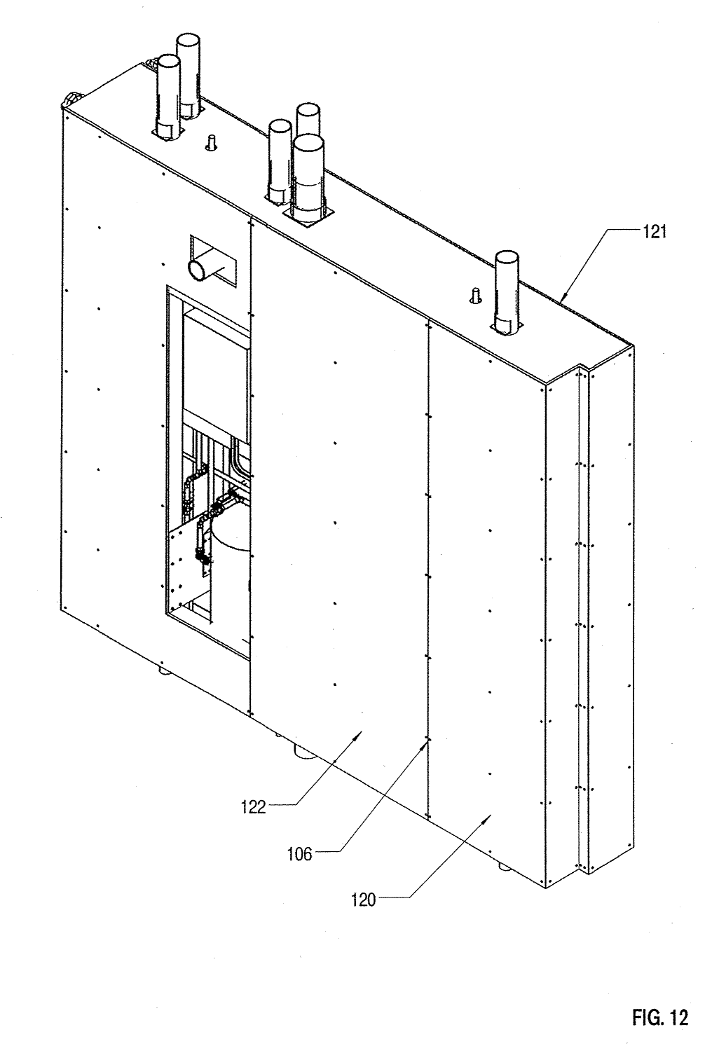

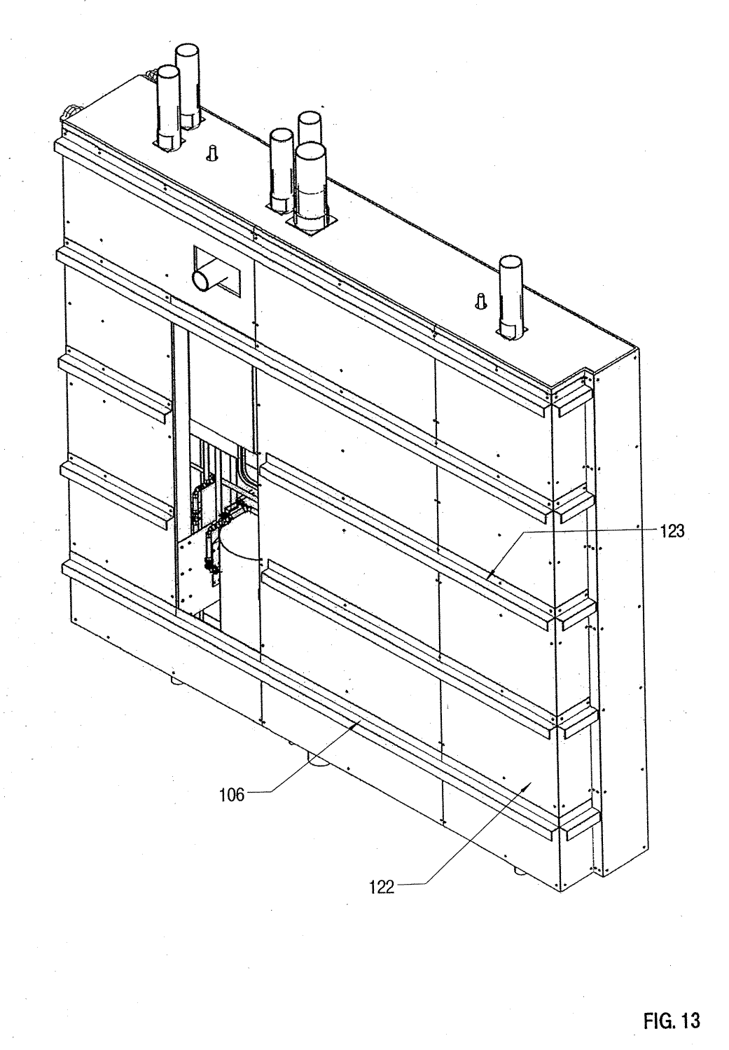

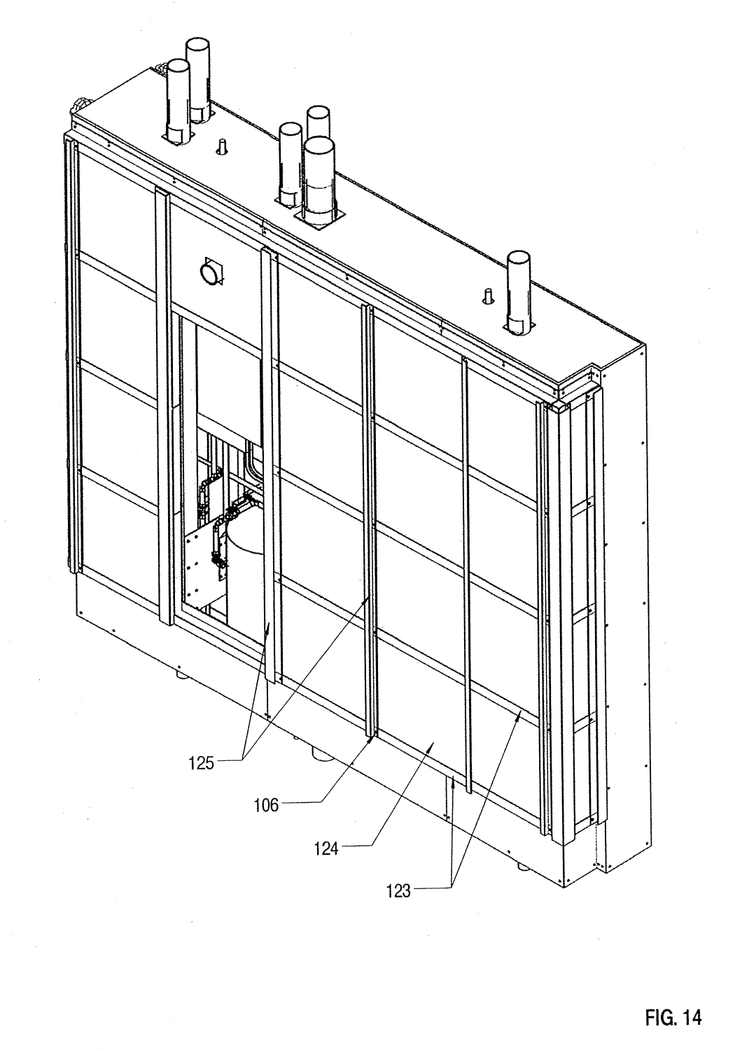

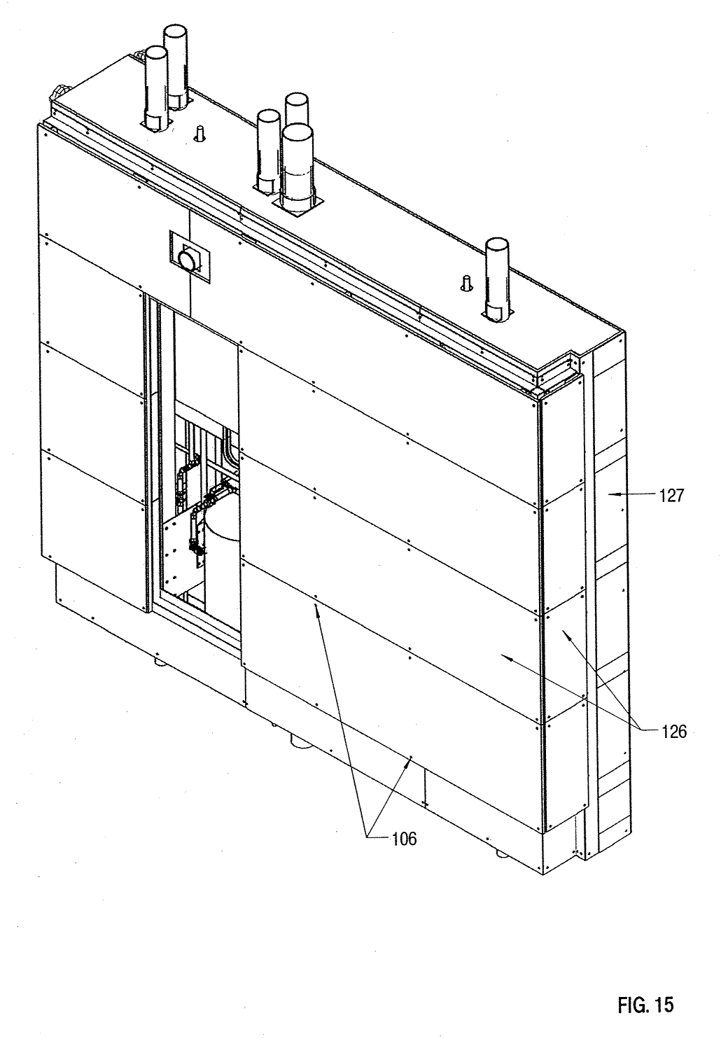

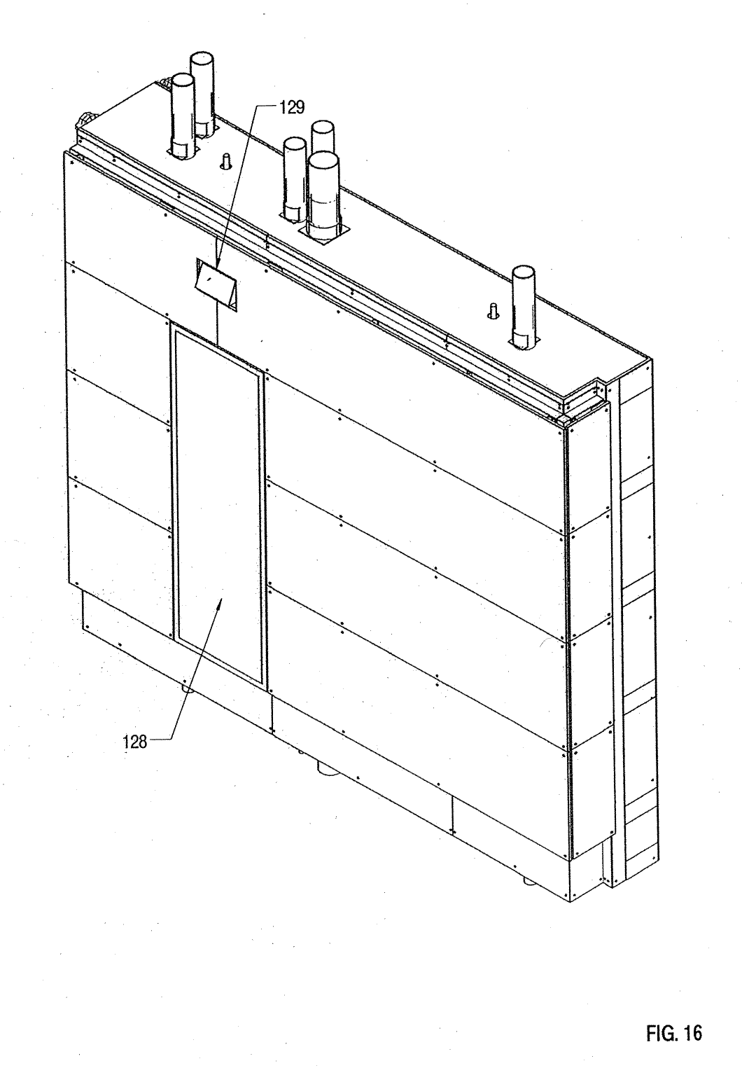

The pre-fabrication of utility wall 101 is completed as illustrated by FIGS. 12-16. An exterior and interior sheathing board 120, 121 is attached over the insulation to the face of the exterior and interior stud walls with manufacturer recommended fasteners 106 as illustrated in FIG. 12. The sheathing 120, 121 is preferably a 12 mm magnesium oxide board, however, other types of fire rated wall panels with safety mechanisms may be used and this example is not meant to be limiting. These boards are precut to size and attached according to a predetermined template to exploit efficiencies in board use. A weather resistant barrier 122 is applied to the exterior face of the exterior sheathing board 120 and integrated into the access panel cavity to provide a weather-tight assembly. The next step as illustrated in FIG. 13 is to attach horizontal furring 123 over the weather resistive barrier 122 with the appropriate fasteners 106. FIG. 14 illustrates the attachment of the rigid insulation 124 between the horizontal furring 123 followed by the attachment of vertical furring channels 125 to the horizontal furring 123 with fasteners 106. As illustrated in FIG. 15, the exterior cladding 126 is attached to the vertical furring channels 125 with appropriate fasteners 106, while the interior finish 127 is applied to the interior sheathing board 121 on the interior of the utility wall 101. The final step, as shown in FIG. 16, is to attach access panel 128 and vent hood 129 and associated trim to complete the utility wall 101. It should be noted that various exterior and interior finish materials can be utilized in the present invention. In as such, attachment of these varying materials may change the steps as outlined above in the attachment of the cladding materials to the base utility wall.

In one example, the utility wall is delivered to a building site as a pre-manufactured, pre-plumbed, pre-wired, prefinished, preassembled and pre-bundled component. Possible cladding materials that may be used for the rain screen panels include, but are not limited to, phenolic resin board, metal panel, cementitious board, wood siding, gypsum reinforced fiber cement panel, precast concrete panel and ceramic tile. The utility wall may be an all-encompassing finished unit on both the interior and exterior sides.

This invention does not preclude the elimination of one or more parts of this utility wall to achieve a more efficient installation method in the field. For example, the utility wall 101 could arrive on site without the horizontal furring 123, rigid insulation 124, vertical furring 125, exterior cladding 126, interior finish material 127, and access panel 128 and vent hood 129.

The utility wall 101 is composed of metal stud framing 105, an integrated acoustical blanket insulation layer 118 within the interior stud of the utility wall 101, an interior sheathing board 121 and an interior finish material 127. The utility wall 101 arrives on site with all of the plumbing 110A-D and necessary blocking 117 associated with the kitchen sink, counters, cabinets, toilet, and shower already in place. The utility wall 101 also includes the shower valves, shower head, and associated trim. The utility wall 101 further contains the unit's electrical panel 114 and water heater 112 behind an accessible panel 128. The exterior side of the utility wall 101 is composed metal stud framing 105, an integrated thermal batt insulation layer 119 within the exterior stud of the utility wall 101, fire-rated exterior sheathing board 120, a weather resistive barrier 122, horizontal furring 123, rigid insulation 124, vertical furring channels 125, exterior cladding 126, an access panel 128, and vent hood and trim 129.

All of the unit's utility connections occur at the utility wall 101. The electrical and communications main lines run in the utility wall 101. At each unit, the electrical service feeds directly into the utility wall's 101 electrical panel 114. Wiring connections to other wall components occur via preinstalled wiring. Electrical and communications connections are carried out at the time of installation of each adjacent utility wall 101. The utility wall 101 has vents 129 located respectively in the bathroom and kitchen on top portions of utility wall 101. The utility wall 101 also has plumbing 110A-B for supply and waste for connecting the bathroom vanity and sink with a sink and kitchen unit. There is a plurality of outlets 116 located in the utility wall 101 for the bathroom and kitchen. The utility wall 101 that arrives on site also has a pre-integrated shower head and shower valves.

It should also be noted that relative terms are meant to help in the understanding of the structures and are not meant to limit the scope of the invention. Similarly, the term “head” is meant to be relative to the term “base,” and the term “top” is meant to be relative to the term “bottom.” It should further be noted that the term “right” is meant to be relative to the term “left,” and the term “horizontal” is meant to be relative to the term “vertical”. It should be further noted that although the present invention is described using certain structures such as fasteners, however, any other types of means can be used to attach the walls.

The terms and expressions that have been employed in the foregoing specification are used as terms of description and not of limitation, and are not intended to exclude equivalents of the features shown and described. This application is intended to cover any adaptations or variations of the present invention. It will be appreciated by those of ordinary skill in the art that any arrangement that is calculated to achieve the same purpose may be substituted for the specific embodiment shown. It is also to be understood that the following claims are intended to cover all of the generic and specific features of the invention herein described and all statements of the scope of the invention which, as a matter of language, might be said to fall there between.

What is claimed is:

1. A pre-manufactured utility wall comprising:
at least one preassembled section;
pre-punched bottom and top plates; and
supply and waste plumbing.

2. The utility wall of claim 1 further comprising:
a reinforcement plate; and
a lifting rod.

3. The utility wall of claim 2 further comprising an access panel.

4. The utility wall of claim 3 further comprising:
an electric panel;
a water heater;
fire protection piping; and
acoustic blanket insulation.

5. The utility wall of claim 3 wherein the utility wall is pre-bundled.

6. A plurality of pre-manufactured utility walls adapted for use in multi-story building construction.

7. The utility walls of claim 6 wherein the utility walls are adapted to be vertically stacked.

8. The utility walls of claim 7 wherein the utility walls comprise:
at least one preassembled section;
pre-punched bottom and top plates; and
supply and waste plumbing.

9. The utility walls of claim 8 further comprising:
a reinforcement plate; and
a lifting rod.

10. The utility walls of claim 9 further comprising an access panel.

11. The utility walls of claim 10 further comprising:
an electric panel;
a water heater;
fire protection piping; and
acoustic blanket insulation.

12. The utility walls of claim 7 wherein the utility walls are identical to each other.

13. The utility walls of claim 7 wherein the utility walls are pre-bundled.

14. A method of assembling a utility wall comprising:
(a) laying out a bottom plate and a top plate of the utility wall to a predetermined length based on a standard template;
(b) pre-punching the bottom and top plates to correspond with anticipated penetrations;
(c) manufacturing a non-weight bearing double stud wall with metal studs and fasteners to fit within stud runners located within the pre-punched bottom and top plates; and
(d) installing one or more of reinforcement plates, lifting rods and framing pockets within the non-weight bearing double stud wall.

15. The method of claim 14 further comprising the steps of:
(a) installing a water heater or other heating system and all supply and waste plumbing;
(b) installing fire protection piping; and
(c) installing an electric panel, wiring and outlets.

16. The method of claim 15 further comprising the steps of:
(a) attaching metal or wood blocking at predetermined locations on the interior side of the non-weight bearing double stud wall;
(b) installing acoustic blanket insulation; and
(c) installing thermal batt insulation.

17. The method of claim 16 further comprising the steps of:
(a) attaching one layer of exterior sheathing board to an exterior side and one layer of an interior sheathing board to an interior of the double stud wall;
(b) applying a weather resistive barrier to the exterior side of the exterior sheathing board;
(c) attaching a horizontal furring to the exterior side of the exterior sheathing board; and
(d) installing a rigid insulation between a horizontal furring.

18. The method of claim 17 further comprising the steps of:
(a) attaching a vertical furring to the horizontal furring on the exterior side of the exterior sheathing board;
(b) installing exterior finished panels and associated flashing components to vertical furring channels;
(c) installing an access panel on the exterior side of the non-weight bearing double stud wall; and
(d) installing interior finish material on an interior sheathing board.
